(19) United States
(12) Patent Application Publication
(10) Pub. No.: US 2026/0052097 A1
(43) Pub. Date: Feb. 19, 2026

(54) RESILIENCE AGAINST UNKNOWN DENIAL-OF-SERVICE ATTACKS VIA MULTIPATH COMMUNICATIONS

(71) Applicants: University of Kansas, Lawrence, KS (US); Wichita State University, Wichita, KS (US)

(72) Inventors: Hyuck M. Kwon, Wichita, KS (US); Rémi A. Chou, Wichita, KS (US); Taejoon Kim, Lawrence, KS (US); Rumia Sultana, Wichita, KS (US); Srilekha Dodda, Wichita, KS (US)

(73) Assignees: University of Kansas, Lawrence, KS (US); Wichita State University, Wichita, KS (US)

(21) Appl. No.: 18/747,150

(22) Filed: Jun. 18, 2024

Related U.S. Application Data
(60) Provisional application No. 63/521,810, filed on Jun. 19, 2023.

(51) Int. Cl. H04L 45/24; H04L 9/32; H04L 45/00; H04W 84/06

(52) U.S. Cl. CPC H04L 45/24; H04L 9/3236; H04L 45/20; H04W 84/06

(57) ABSTRACT

Presented herein is an effective protection method against unknown and unanticipated denial-of-service attacks and guarantee mission critical message delivery. Multipath communication may be leveraged as a preventive device-centric mechanism to ensure message deliveries in the event of unknown denial-of-service attacks. The mechanism may complement other device-centric mitigation techniques as the mechanism does not wait for the detection of adversaries in the network and is attack-agnostic. In particular, the technique may be effective against a wide range of denial-of-service attacks at any protocol layer.

### CROSS-REFERENCE TO RELATED APPLICATIONS

The application claims the benefit of and priority to U.S. Provisional Patent Application No. 63/521,810, titled “Resilience Against Unknown Denial-of-Service Attacks via Multipath Communications,” filed Jun. 19, 2023, which is incorporated by reference herein in its entirety for any and all purposes.

### STATEMENT OF GOVERNMENT SUPPORT

This invention was made with government support under 2226447 awarded by the National Science Foundation. The government has certain rights in the invention.

### TECHNICAL FIELD

The present application relates to the field of communications, and in particular encoding and decoding communications over multi-path communications.

### BACKGROUND

Existing 5G systems may be subject to countless new and evolving attacks against 5G networks. When the communication system is attacked by a denial-of-service attack, the mission critical message cannot be delivered, leading to severe degradation of communications among the nodes of the network.

### SUMMARY

To address these and other technical challenges, presented herein is an effective protection method against unknown and unanticipated denial-of-service attacks and guarantee mission critical message delivery. Multipath communication may be leveraged as a preventive device-centric mechanism to ensure message deliveries in the event of unknown denial-of-service attacks. The mechanism may complement other device-centric mitigation techniques as the mechanism does not wait for the detection of adversaries in the network and is attack-agnostic. In particular, the technique may be effective against a wide range of denial-of-service attacks at any protocol layer.

Under the coding strategy, a message M may be encoded into L packets and each packet may be routed through L different communication paths, with the guarantee that any denial-of-service attacks on any z paths do not prevent recovery of the message at the receiver, where z<L is a parameter. Specifically, coding strategies can be considered for both (i) unencrypted data and (ii) already-encrypted data. This technique may rely on the design of ad-hoc coding schemes with lightweight complexity that solely rely on exclusive-or (XOR) operations and do not rely on computationally demanding finite field operations.

At least one aspect is directed to systems, methods, or computer-readable media for encoding messages to send via multi-path communications. A first device including one or more processors coupled with memory may identify from a first message, a plurality of portions of the first message. Each portion may correspond to a respective segment of the first message to be transmitted via a plurality of paths to a second device. The first device may determine a plurality of nonces to encode the plurality of portions of the first message. The device may generate a corresponding second message of a plurality of second messages. The corresponding second message may include: (i) a first value based at least on at least one portion of the plurality of portions and a first nonce of the plurality of nonces and (ii) a second value that is based at least on a second nonce of the plurality of nonces. The device may transmit, via each path of the plurality of paths, the corresponding second message, to cause the second device to decode the first message using at least a subset of the plurality of second messages.

In some embodiments the first device may determine a number of messages to transmit based at least on one of the number of base stations between the first device and the second device, the number of paths between the first device and the second device or the size of the first message. In some embodiments, the first device may include an unmanned aerial vehicle in communication with the second device via a plurality of base stations corresponding to the plurality of paths.

In some embodiments, the plurality of second messages may include: (i) a first encoded message comprising (i) a respective first value based on a combination of a first portion of the plurality of portions and the first nonce and (ii) a respective second value corresponding to the second nonce; (ii) a second encoded message comprising (i) a respective first value corresponding to the first nonce and (ii) a respective second value based on a combination of a second portion of the plurality of portions and the second nonce; and (iii) a third encoded message comprising (i) a respective first value based on a combination of the first portion and the second nonce and (ii) a respective second value based on a combination of the second portion and the first nonce

At least one aspect is directed to systems, methods, or computer-readable media for decoding messages to send via multi-path communications. A first device including one or more processors coupled with memory may receive, via at least a subset of a plurality of paths between the first device and the second device, a plurality of first messages. Each message may include (i) a first value based at least on at least one portion of a plurality of portions and a first nonce of a plurality of nonces and (ii) a second value based at least on a second nonce of the plurality of nonces. The first device may identify, using the first value and the second value in each of the plurality of first messages, the plurality of nonces used to encode the plurality of portions of a second message. The first device may determine, from each of the plurality of first messages, the at least one portion of the plurality of portions based on (i) the first value and (ii) at least one of the first nonce or the second nonce. The first device may generate a second message including the plurality of portions determined from the plurality of first messages.

In some embodiments, the first device may determine the at least one portion of the plurality of portions based on an exclusive-or operation on (i) the first value and (ii) at least one of the first nonce or the second nonce. In some embodiments, the first device may include an unmanned aerial vehicle in communication with the second device via a plurality of base stations corresponding to the plurality of paths.

In some embodiments, the plurality of second messages may include: (i) a first encoded message comprising (i) a respective first value based on a combination of a first portion of the plurality of portions and the first nonce and (ii) a respective second value corresponding to the second nonce; (ii) a second encoded message comprising (i) a respective first value corresponding to the first nonce and (ii) a respective second value based on a combination of a second portion of the plurality of portions and the second nonce; and (iii) a third encoded message comprising (i) a respective first value based on a combination of the first portion and the second nonce and (ii) a respective second value based on a combination of the second portion and the first nonce.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 depicts is a block diagram of a system for communicating encoded data in a networked environment in accordance with an illustrative embodiment;

FIG. 2 depicts a block diagram of an environment in which unmanned aerial vehicles communicate over multiple paths in accordance with an illustrative embodiment; and

FIG. 3 depicts a flow diagram of a method of communicating encoded messages via multipath communications to counteract against attacks along any of the paths, in accordance with an illustrative embodiment.

### DETAILED DESCRIPTION

Following below are more detailed descriptions of various concepts related to, and embodiments of, systems and methods for communicating encoded messages via multipath communications to counteract against attacks along any of the paths. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes coding schema exhibiting resilience against attacks via multipath communications.

Section B describes systems and methods for communicating encoded messages via multipath communications.

### A. Coding Schema Exhibiting Resilience Against Attacks Via Multipath Communications

### I. Setting

Any Base Station cannot learn M: Quantum-resistant protocol.

Proactive rather than reactive design.

Does not solely rely on the security provided by the Base Station.

Defeats entire classes of attacks at any layer on a single Base Station.

No need to cooperate with Base Station.

### II. Codes for Unencrypted Data

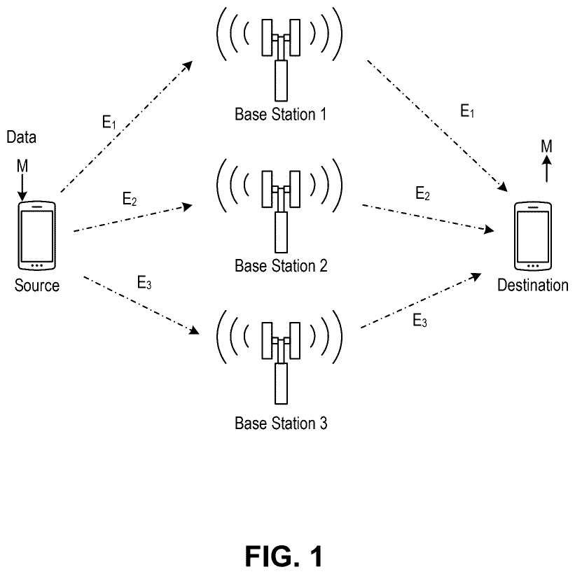

Referring now to FIG. 1, depicted is a block diagram of a system for communicating encoded data in a networked environment. Example for threshold t=2 and N=3 base stations. Two shares may be used to reconstruct the data. Any single share does not leak any information about the data (quantum resiliency).

### Encoding

The data M is split into 2 parts

$$M = {M}_{1} ‖ {M}_{2} .$$

R₁ and R₂ are two independent sequences of bits uniformly distributed over {0,1}^{|M|/2}. The three encoded parts are

$${E}_{1} = ( \begin{matrix}{R}_{1} \\ {M}_{2} ⊕ {R}_{2}\end{matrix} ) , {E}_{2} = ( \begin{matrix}{M}_{1} ⊕ {R}_{1} \\ {R}_{2}\end{matrix} ) , {E}_{3} = ( \begin{matrix}{M}_{1} ⊕ {R}_{2} \\ {R}_{2} ⊕ {R}_{1}\end{matrix} )$$

Size of the share is optimal in this setting (|M|)
Total size of the random sequences is optimal in this setting (|M|)
Complexity of encoding is 2×|M|

### Decoding

M=M₁∥M₂ can be recovered from any two shares (E₁, E₂), (E₁, E₃), or (E₂, E₃). The following notation may be used:

$$\begin{matrix}{E}_{1} = ( \begin{matrix}{E}_{1 , 1} \\ {E}_{1 , 2}\end{matrix} ) = ( \begin{matrix}{R}_{1} \\ {M}_{2} ⊕ {R}_{2}\end{matrix} ) , {E}_{2} = ( \begin{matrix}{E}_{2 , 1} \\ {E}_{2 , 2}\end{matrix} ) = ( \begin{matrix}{M}_{1} ⊕ {R}_{1} \\ {R}_{2}\end{matrix} ) , \\ {E}_{3} = ( \begin{matrix}{E}_{3 , 1} \\ {E}_{3 , 2}\end{matrix} ) = ( \begin{matrix}{M}_{1} ⊕ {R}_{2} \\ {R}_{2} ⊕ {R}_{1}\end{matrix} ) .\end{matrix}$$

1) (E₁, E₂):

$${R}_{1} , {R}_{2}$$

$${M}_{1} = {E}_{2 , 1} ⊕ {R}_{1} ,$$

$${M}_{2} = {E}_{1 , 2} ⊕ {R}_{2} ,$$

Complexity of decoding is |M|
2) (E₁, E₃):

$$\begin{matrix}{R}_{1} \\ {M}_{2} = {E}_{3 , 2} ⊕ {R}_{1} , \\ {R}_{2} = {E}_{1 , 2} ⊕ {M}_{2} , \\ {M}_{1} = {E}_{3 , 2} ⊕ {R}_{2} .\end{matrix}$$

Complexity of decoding is

$$\frac{3}{2} \times \vert M \vert$$

3) (E₂, E₃):

$$\begin{matrix}{R}_{2} \\ {M}_{1} = {E}_{3 , 1} ⊕ {R}_{2} , \\ {R}_{1} = {E}_{2 , 1} ⊕ {M}_{1} , \\ {M}_{2} = {E}_{3 , 2} ⊕ {R}_{1} .\end{matrix}$$

Complexity of decoding is

$$\frac{3}{2} \times \vert M \vert$$

### Security Analysis

For j=∈{1,2,3}, I(Eⱼ;M)=0, i.e., Eⱼ is independent of M.

The following may be obtained:

$$\begin{matrix}I ( {E}_{3} ; M ) \begin{matrix}( a ) \\ =\end{matrix} I ( {M}_{2} ⊕ {R}_{1} , {M}_{1} ⊕ {R}_{2} ; M ) \\ \begin{matrix}( b ) \\ =\end{matrix} I ( M ⊕ ( {R}_{2} ‖ {R}_{1} ) ; M ) \\ \begin{matrix}( c ) \\ =\end{matrix} H ( M ⊕ ( {R}_{2} ‖ {R}_{1} ) ) - H ( M ⊕ ( {R}_{2} ‖ {R}_{1} ) \vert M \\ \begin{matrix}( d ) \\ =\end{matrix} H ( M ⊕ ( {R}_{2} \vert \vert {R}_{1} ) ) - H ( ( {R}_{2} ‖ {R}_{1} ) \vert M ) \\ \begin{matrix}( e ) \\ =\end{matrix} H ( M ⊕ ( {R}_{2} \vert \vert {R}_{1} ) ) - H ( ( {R}_{2} ‖ {R}_{1} ) ) \\ \begin{matrix}( f ) \\ =\end{matrix} \vert M \vert - H ( ( {R}_{2} ‖ {R}_{1} ) ) \\ \begin{matrix}( g ) \\ =\end{matrix} \vert M \vert - \vert M \vert \\ = 0 ,\end{matrix}$$

where (a) holds by the definition of E₃, (b) holds by the definition of M, (c) holds by the definition of mutual information, (d) holds because H(M⊕(R₂∥R₁), M|M)=H((R₂∥R₁), M|M)=H((R₂∥R₁)|M), where the third equality hold by chain rule for entropy, (e) holds because R₁, R₂ are independent of M, (f) holds by the property of entropy, (g) holds by the generation of R₁, R₂.

$$\begin{matrix}I ( {E}_{2} ; M ) = I ( {R}_{2} , {M}_{1} ) ⊕ {R}_{1} ; {M}_{1} , {M}_{2} ) \\ = I ( {M}_{1} ⊕ {R}_{1} ; {M}_{1} , {M}_{2} ) \\ = I ( {M}_{1} ⊕ {R}_{1} ; {M}_{1} ) \\ = H ( {M}_{1} ⊕ {R}_{1} - H ( {M}_{1} ⊕ {R}_{1} \vert {M}_{1} ) \\ = H ( {M}_{1} ⊕ {R}_{1} - H ( {R}_{1} \vert {M}_{1} ) \\ = H ( {M}_{1} ⊕ {R}_{1} - H ( {R}_{1} ) \leq \vert M \vert / 1 - H ( {R}_{1} ) \\ = \vert M \vert / 2 - \vert M \vert / 2 \\ = 0 , \\ I ( {E}_{1} ; M ) = I ( {R}_{1} , {M}_{2} ) ⊕ {R}_{1} ; {M}_{1} , {M}_{2} ) \\ = I ( {M}_{2} ⊕ {R}_{2} ; {M}_{1} , {M}_{2} ) \\ = I ( {M}_{2} ⊕ {R}_{2} ; {M}_{2} ) \\ = H ( {M}_{2} ⊕ {R}_{2} - H ( {M}_{2} ⊕ {R}_{2} \vert {M}_{2} ) \\ = H ( {M}_{2} ⊕ {R}_{2} - H ( {R}_{2} \vert {M}_{2} ) \\ = H ( {M}_{2} ⊕ {R}_{2} - H ( {R}_{2} ) \leq \vert M \vert / 2 - H ( {R}_{2} ) \\ = \vert M \vert / 2 - \vert M \vert / 2 \\ = 0.\end{matrix}$$

### Model for Binary Symmetric Channel

The bits of the shares E; can be defined with E_{i,j} where (i,j)∈{1,2,3}. E_{i,j} goes through the binary symmetric channel with parameter ∈. If the output is defined as Ê_{i,j}, then there is:

$$ℙ [ {E}_{i , j} \neq ] = ϵ \qquad ( 1 )$$

1) Probability of error for decoding:
a) Recovering M from (E₁, E₂):

$$\begin{matrix}{M}_{1} = {E}_{2 , 1} ⊕ {E}_{1 , 1} , \\ {M}_{2} = {E}_{1 , 2} ⊕ {E}_{2 , 2} .\end{matrix}$$

Data received at the destination

$${M}_{1} = {E}_{2 , 1} ⊕ {E}_{1 , 1} , \qquad ( 2 )$$

$${M}_{2} = {E}_{1 , 2} ⊕ {E}_{2 , 2} .$$

$${ℙ}_{( {E}_{1} , {E}_{2} )} [ {M}_{1} \neq {M}_{1} ] = \{ ℙ [ {\hat{E}}_{2 , 1} flipped ] \times ℙ [ {\hat{E}}_{1 , 1} not flipped ] \} + \{ ℙ [ {\hat{E}}_{2 , 1} not flipped ] \times ℙ [ {\hat{E}}_{1 , 1} flipped ] \}$$

$$= \{ ϵ ( 1 - ϵ ) \} + \{ ϵ ( 1 - ϵ ) \}$$

$$= 2 ϵ ( 1 - ϵ ) .$$

$${ℙ}_{( {E}_{1} , {E}_{2} )} [ {M}_{2} \neq {M}_{2} ] = \{ ℙ [ {\hat{E}}_{1 , 2} flipped ] \times ℙ [ {\hat{E}}_{2 , 2} not flipped ] \} + \{ ℙ [ {\hat{E}}_{1 , 2} not flipped ] \times ℙ [ {\hat{E}}_{2 , 2} flipped ] \} \qquad ( 3 )$$

$$= \{ ϵ ( 1 - ϵ ) \} + \{ ϵ ( 1 - ϵ ) \}$$

$$= 2 ϵ ( 1 - ϵ ) .$$

From Equations (2) and (3), the following may be obtained:

$${ℙ}_{( {E}_{1} , {E}_{2} )} [ M \neq \hat{M} ] = ℙ [ {M}_{1} \neq {M}_{1} ] + ℙ [ {M}_{2} \neq {M}_{2} ]$$

$$= 4 ϵ ( 1 - ϵ ) .$$

b) Recovering M from (E₁, E₂):

$${M}_{1} = {E}_{3 , 1} ⊕ {E}_{1 , 2} ⊕ {E}_{3 , 2} ⊕ {E}_{1 , 1} ,$$

$${M}_{2} = {E}_{3 , 2} ⊕ {E}_{1 , 1} .$$

Data Received at the Destination

$${\hat{M}}_{1} = {\hat{E}}_{3 , 1} ⊕ {\hat{E}}_{1 , 2} ⊕ {\hat{E}}_{3 , 2} ⊕ {\hat{E}}_{1 , 1} ,$$

$${\hat{M}}_{2} = {\hat{E}}_{3 , 2} ⊕ {\hat{E}}_{1 , 1} .$$

Probability of 1 bit flipped

$${ℙ}_{( {E}_{1} , {E}_{3} )} [ {M}_{1} \neq {\hat{M}}_{1} ] = \{ ℙ [ {\hat{E}}_{3 , 1} flipped ] \times ℙ [ {\hat{E}}_{1 , 2} not flipped ] \times ℙ [ {\hat{E}}_{3 , 2} not flipped ] \times ℙ [ {\hat{E}}_{1 , 1} not flipped ] \} + \{ ℙ {\hat{E}}_{3 , 1} not flipped ] \times ℙ [ {\hat{E}}_{1 , 2} flipped ] \times ℙ [ {\hat{E}}_{3 , 2} not flipped ] \times ℙ [ {\hat{E}}_{1 , 1} not flipped ] \} + \{ ℙ [ {\hat{E}}_{3 , 1} not flipped ] \times ℙ [ {\hat{E}}_{1 , 2} not flipped ] \times ℙ [ {\hat{E}}_{3 , 2} not flipped ] \times ℙ [ {\hat{E}}_{1 , 1} ] \} + \{ ℙ [ {\hat{E}}_{3 , 1} not flipped ] \times ℙ [ {\hat{E}}_{1 , 2} not flipped ] \times ℙ [ {\hat{E}}_{3 , 2} not flipped ] \times ℙ [ {\hat{E}}_{1 , 1} ] \} \qquad ( 4 )$$

$$= \{ {ϵ ( 1 - ϵ )}^{3} \} + \{ {ϵ ( 1 - ϵ )}^{3} \} + \{ {ϵ ( 1 - ϵ )}^{3} \} + \{ {ϵ ( 1 - ϵ )}^{3} \}$$

$$= 4 ϵ {( 1 - ϵ )}^{3} .$$

Probability of 3 bits flipped

$${ℙ}_{( {E}_{1} , {E}_{3} )}^{″} [ {M}_{1} \neq {\hat{M}}_{1} ] = \{ ℙ [ {\hat{E}}_{3 , 1} flipped ] \times ℙ [ {\hat{E}}_{1 , 2} flipped ] \times ℙ [ {\hat{E}}_{3 , 2} flipped ] \times ℙ [ {\hat{E}}_{1 , 1} not flipped ] \} + ℙ {\hat{E}}_{3 , 1} flipped ] \times ℙ [ {\hat{E}}_{1 , 2} flipped ] \times ℙ [ {\hat{E}}_{3 , 2} not flipped ] \times ℙ [ {\hat{E}}_{1 , 1} flipped ] \} + \{ ℙ [ {\hat{E}}_{3 , 1} not flipped ] \times ℙ [ {\hat{E}}_{1 , 2} not flipped ] \times ℙ [ {\hat{E}}_{3 , 2} flipped ] \times ℙ [ {\hat{E}}_{1 , 1} flipped ] \} + ℙ [ {\hat{E}}_{3 , 1} not flipped ] \times ℙ [ {\hat{E}}_{1 , 2} flipped ] \times ℙ [ {\hat{E}}_{3 , 2} flipped ] \times ℙ [ {\hat{E}}_{1 , 1} flipped ] \} \qquad ( 5 )$$

$$= \{ {ϵ ( 1 - ϵ )}^{3} \} + \{ {ϵ ( 1 - ϵ )}^{3} \} + \{ {ϵ ( 1 - ϵ )}^{3} \} + \{ {ϵ ( 1 - ϵ )}^{3} \}$$

$$= 4 ϵ {( 1 - ϵ )}^{3} .$$

From Equations (4) and (5), the following may be obtained:

$${ℙ}_{( {E}_{1} {E}_{3} )} [ {M}_{1} \neq {\hat{M}}_{1} ] = {ℙ}^{′} [ {M}_{1} \neq {\hat{M}}_{1} ] + {ℙ}^{″} [ {M}_{1} \neq {\hat{M}}_{1} ] \qquad ( 6 )$$

$$= 4 {ϵ ( 1 - ϵ )}^{3} + 4 {ϵ}^{3} ( 1 - ϵ )$$

$${ℙ}_{( {E}_{1} , {E}_{3}} ) [ {M}_{2} \neq {\hat{M}}_{2} ] = \{ ℙ [ {\hat{E}}_{3 , 2} flipped ] \times ℙ [ {\hat{E}}_{1 , 1} not flipped ] \} + \{ ℙ [ {\hat{E}}_{3 , 2} not flipped ] \times ℙ [ {\hat{E}}_{1 , 1} flipped ] \} \qquad ( 7 )$$

$$= \{ ϵ ( 1 - ϵ ) \} + \{ ϵ ( 1 - ϵ ) \}$$

$$= 2 ϵ ( 1 - ϵ ) .$$

From Equations (6) and (7), the following may be obtained:

$${ℙ}_{( {E}_{1} , {E}_{2} )} [ M \neq \hat{M} ] \leq ℙ [ {M}_{1} \neq {\hat{M}}_{1} ] + ℙ [ {M}_{2} \neq {\hat{M}}_{2} ]$$

$$= 4 ϵ {( 1 - ϵ )}^{3} + 4 {ϵ}^{3} ( 1 - ϵ ) + 2 ϵ ( 1 - ϵ )$$

$$= 2 ϵ ( 1 - ϵ ) [ 2 {( 1 - ϵ )}^{2} + 2 {ϵ}^{2} + 1 ] .$$

c) Recovering M from (E₂, E₃):

$${M}_{1} = {E}_{3 , 1} ⊕ {E}_{2 , 2} ,$$

$${M}_{2} = {E}_{3 , 2} ⊕ {E}_{2 , 1} ⊕ {E}_{3 , 1} ⊕ {E}_{2 , 2} .$$

Data received at the destination

$${\hat{M}}_{1} = {\hat{E}}_{3 , 1} ⊕ {\hat{E}}_{2 , 2} , \qquad ( 8 )$$

$${\hat{M}}_{2} = {\hat{E}}_{3 , 2} ⊕ {\hat{E}}_{2 , 1} ⊕ {\hat{E}}_{3 , 1} ⊕ {\hat{E}}_{2 , 2} .$$

$$\begin{matrix}{ℙ}_{( {E}_{2} , {E}_{3} )} [ {M}_{1} \neq {\hat{M}}_{1} ] = \{ ℙ [ {\hat{E}}_{3 , 1} flipped ] \times ℙ [ {\hat{E}}_{2 , 2} not flipped ] \} + \{ ℙ [ {\hat{E}}_{3 , 1} not flipped ] \times ℙ [ {\hat{E}}_{2 , 2} flipped ] \} \\ = \{ ϵ ( 1 - ϵ ) \} + \{ ϵ ( 1 - ϵ ) \} \\ = 2 ϵ ( 1 - ϵ )\end{matrix} .$$

Probability of 1 bit flipped

$$\begin{matrix}{ℙ}_{( {E}_{2} , {E}_{3} )}^{′} [ {M}_{2} \neq {\hat{M}}_{2} ] = \begin{matrix}\{ ℙ [ {\hat{E}}_{3 , 2} flipped ] \times ℙ [ {\hat{E}}_{2 , 1} not flipped ] \times ℙ [ {\hat{E}}_{3 , 1} not flipped ] \times ℙ [ {\hat{E}}_{2 , 2} not flipped ] \} + \\ \{ ℙ [ {\hat{E}}_{3 , 2} not flipped ] \times ℙ [ {\hat{E}}_{2 , 1} not flipped ] \times ℙ [ {\hat{E}}_{3 , 1} not flipped ] \times ℙ [ {\hat{E}}_{2 , 2} flipped ] \}\end{matrix} \\ = \begin{matrix}\{ ℙ [ {\hat{E}}_{3 , 2} flipped ] \times ℙ [ {\hat{E}}_{2 , 1} not flipped ] \times ℙ [ {\hat{E}}_{3 , 1} not flipped ] \times ℙ [ {\hat{E}}_{2 , 2} not flipped ] \} + \\ \{ ℙ [ {\hat{E}}_{3 , 2} not flipped ] \times ℙ [ {\hat{E}}_{2 , 1} not flipped ] \times ℙ [ {\hat{E}}_{3 , 1} not flipped ] \times ℙ [ {\hat{E}}_{2 , 2} flipped ] \}\end{matrix} \\ = \{ {ϵ ( 1 - ϵ )}^{3} \} + \{ {ϵ ( 1 - ϵ )}^{3} \} + \{ {ϵ ( 1 - ϵ )}^{3} + \{ {ϵ ( 1 - ϵ )}^{3} \} \\ = 4 {ϵ ( 1 - ϵ )}^{3}\end{matrix} . \qquad ( 9 )$$

Probability of 3 bits flipped

$$\begin{matrix}{ℙ}_{( {E}_{2} , {E}_{3} )}^{″} [ {M}_{2} \neq {\hat{M}}_{2} ] = \begin{matrix}\{ ℙ [ {\hat{E}}_{3 , 2} flipped ] \times ℙ [ {\hat{E}}_{2 , 1} flipped ] \times ℙ [ {\hat{E}}_{3 , 1} flipped ] \times ℙ [ {\hat{E}}_{2 , 2} not flipped ] \} + \\ \{ ℙ [ {\hat{E}}_{3 , 2} flipped ] \times ℙ [ {\hat{E}}_{2 , 1} flipped ] \times ℙ [ {\hat{E}}_{3 , 1} not flipped ] \times ℙ [ {\hat{E}}_{2 , 2} flipped ] \} + \\ \{ ℙ [ {\hat{E}}_{3 , 2} flipped ] \times ℙ [ {\hat{E}}_{2 , 1} not flipped ] \times ℙ [ {\hat{E}}_{3 , 1} flipped ] \times ℙ [ {\hat{E}}_{2 , 2} flipped ] \} + \\ \{ ℙ [ {\hat{E}}_{3 , 2} not flipped ] \times ℙ [ {\hat{E}}_{2 , 1} flipped ] \times ℙ [ {\hat{E}}_{3 , 1} flipped ] \times ℙ [ {\hat{E}}_{2 , 2} flipped ] \}\end{matrix} \\ = \{ {ϵ}^{3} ( 1 - ϵ ) \} + \{ {ϵ}^{3} ( 1 - ϵ ) \} + \{ {ϵ}^{3} ( 1 - ϵ ) \} + \{ {ϵ}^{3} ( 1 - ϵ ) \} \\ = 4 {ϵ}^{3} ( 1 - ϵ )\end{matrix} . \qquad ( 10 )$$

From Equations (9) and (10), the following may be obtained:

$$\begin{matrix}{ℙ}_{( {E}_{2} , {E}_{3} )} [ {M}_{2} \neq {\hat{M}}_{2} ] = {ℙ}^{′} [ {M}_{2} \neq {\hat{M}}_{2} ] + {ℙ}^{″} [ {M}_{2} \neq {\hat{M}}_{2} ] \\ = 4 {ϵ ( 1 - ϵ )}^{3} + 4 {ϵ}^{3} ( 1 - ϵ )\end{matrix} . \qquad ( 11 )$$

From Equations (8) and (11), the following may be obtained:

$$\begin{matrix}{ℙ}_{( {E}_{2} , {E}_{3} )} [ M \neq \hat{M} ] \leq ℙ [ {M}_{1} \neq {\hat{M}}_{1} ] + ℙ [ {M}_{2} \neq {\hat{M}}_{2} ] \\ = 2 ϵ ( 1 - ϵ ) + 4 {ϵ ( 1 - ϵ )}^{3} + 4 {ϵ}^{3} ( 1 - ϵ ) \\ = 2 ϵ ( 1 - ϵ ) [ 1 + 2 {( 1 - ϵ )}^{2} + 2 {ϵ}^{2} ]\end{matrix} .$$

2) BER:

$$\begin{matrix}BER \leq \frac{1}{2} max ( {ℙ}_{( {E}_{1} , {E}_{2} )} , {ℙ}_{( {E}_{1} , {E}_{3} )} , {ℙ}_{( {E}_{2} , {E}_{3} )} ) \\ = ϵ ( 1 - ϵ ) [ 1 + 2 {( 1 - ϵ )}^{2} + 2 {ϵ}^{2} ] \\ \leq 3 ϵ + 2 {ϵ}^{3} \\ \approx 3 ϵ\end{matrix}$$

### I. Codes for Already-Encrypted Data

### Encoding

The data M is split into 2 parts

$$M = {M}_{1} \vert \vert {M}_{2} .$$

The three encoded parts are

$${E}_{1} {=}^{△} {M}_{1}$$

$${E}_{2} {=}^{△} {M}_{2}$$

$${E}_{3} {=}^{△} {M}_{1} ⊕ {M}_{2}$$

Size of the share is optimal in this setting (|M|)
Encoding complexity: The number of bit-wise XOR operations is

$$\frac{\vert M \vert}{2}$$

### Decoding

M=M₁∥M₂ can be recovered from any two shares (E₁, E₂), (E₁, E₃), or (E₂, E₃).
1) (E₁, E₂):

$${M}_{1} = {E}_{1} ,$$

$${M}_{2} = {E}_{2} .$$

Decoding complexity: The number of bit-wise XOR operations is 0
2) (E₁, E₃):

$${M}_{1} = {E}_{1} ,$$

$${M}_{2} = {E}_{3} ⊕ {M}_{1} .$$

Decoding complexity: The number of bit-wise XOR operations

$$\frac{1}{2} \times \vert M \vert$$

3) (E₂, E₃):

$${M}_{2} = {E}_{2} ,$$

$${M}_{1} = {E}_{3} ⊕ {M}_{2} .$$

Decoding complexity: The number of bit-wise XOR operations is

$$\frac{1}{2} \times \vert M \vert$$

Average decoding complexity: The average number of bit-wise XOR operations is

$$\frac{1}{3} \times \vert M \vert .$$

4) Optimality:

E₁, E₂, E₃ correspond to n=3 symbols in

$$𝒳 {=}^{△} \{ 0 , 1 \} \frac{\vert M \vert}{2} .$$

Data M corresponds to k=2 symbols in

[symbol]

Here, n−k=1: Maximum Distance Separable (MDS) code. Can correct up to 1 erased symbol.

### Model for Binary Symmetric Channel

The bits of the shares Eⱼ can be defined with E_{i,j} where (i,j)∈{1, 2, 3}. E_{i,j} goes through the binary symmetric channel with parameter ϵ. If the output is defined as Ê_{i,j}, then the following may be obtained:

$$ℙ [ {E}_{i , j} \neq {\hat{E}}_{i , j} ] = ϵ \qquad ( 12 )$$

1) Probability of error for decoding:
a) Recovering M from (E₁, E₂):

$${M}_{1} = {E}_{1} ,$$

$${M}_{2} = {E}_{2} .$$

Data received at the destination

$${\hat{M}}_{1} = {\hat{E}}_{1} ,$$

$${\hat{M}}_{2} = {\hat{E}}_{2} .$$

$$\begin{matrix}{ℙ}_{( {E}_{1} , {E}_{2} )} [ {M}_{1} \neq {\hat{M}}_{1} ] = \{ ℙ [ {\hat{E}}_{1} flipped ] \\ = ϵ .\end{matrix} \qquad ( 13 )$$

$$\begin{matrix}{ℙ}_{( {E}_{1} , {E}_{2} )} [ {M}_{2} \neq {\hat{M}}_{2} ] = \{ ℙ [ {\hat{E}}_{2} flipped ] \\ = ϵ .\end{matrix} \qquad ( 14 )$$

From Equations (13) and (14), the following may be obtained:

$$\begin{matrix}{ℙ}_{( {E}_{1} , {E}_{2} )} [ M \neq \hat{M} ] = ℙ [ {M}_{1} \neq {\hat{M}}_{1} ] + ℙ [ {M}_{2} \neq {\hat{M}}_{2} ] \\ = 2 ϵ .\end{matrix}$$

b) Recovering M from (E₁, E₃):

$${M}_{1} = {E}_{1} ,$$

$${M}_{2} = {E}_{3} ⊕ {M}_{1} .$$

Data received at the destination

$${\hat{M}}_{1} = {\hat{E}}_{1} ,$$

$${\hat{M}}_{2} = {\hat{E}}_{3} ⊕ {\hat{M}}_{1} .$$

Probability of a bit flipped

$$\begin{matrix}{ℙ}_{( {E}_{1} , {E}_{3} )}^{′} [ {M}_{1} \neq {\hat{M}}_{1} ] = \{ ℙ [ {\hat{E}}_{1} flipped ] \\ = ϵ .\end{matrix} \qquad ( 15 )$$

$$\begin{matrix}{ℙ}_{( {E}_{1} , {E}_{3} )}^{′} [ {M}_{2} \neq {\hat{M}}_{1} ] = \{ ℙ [ {\hat{E}}_{3} ⊕ {\hat{M}}_{1} flipped ] \\ = ϵ .\end{matrix} \qquad ( 16 )$$

From Equations (15) and (16), the following may be obtained:

$${ℙ}_{( {E}_{1} , {E}_{3} )} [ M \neq \hat{M} ] \leq ℙ [ {M}_{1} \neq {\hat{M}}_{1} ] + ℙ [ {M}_{2} \neq {\hat{M}}_{2} ] = 2 ϵ .$$

c) Recovering M from (E₂, E₃):

$${M}_{2} = {E}_{2} ,$$

$${M}_{1} = {E}_{3} ⊕ {M}_{2} .$$

Data received at the destination

$${\hat{M}}_{2} = {\hat{E}}_{2} ,$$

$${\hat{M}}_{1} = {\hat{E}}_{3} ⊕ {\hat{M}}_{2} .$$

$$\begin{matrix}{ℙ}_{( {E}_{2} , {E}_{3} )} [ {M}_{1} \neq {\hat{M}}_{1} ] = \{ ℙ [ {\hat{E}}_{2} ⊕ {\hat{M}}_{2} flipped ] \\ = ϵ .\end{matrix} \qquad ( 17 )$$

$$\begin{matrix}{ℙ}_{( {E}_{2} , {E}_{3} )}^{′} [ {M}_{2} \neq {\hat{M}}_{2} ] = \{ ℙ [ {\hat{E}}_{2} flipped ] \\ = ϵ .\end{matrix} \qquad ( 18 )$$

From Equations (17) and (18), the following may be obtained:

$${ℙ}_{( {E}_{2} , {E}_{3} )} [ M \neq \hat{M} ] \leq ℙ [ {M}_{1} \neq {\hat{M}}_{1} ] + ℙ [ {M}_{2} \neq {\hat{M}}_{2} ] = 2 ϵ .$$

2) Bit Error Rate (BER):

$$BER \leq \frac{1}{2} max ( {ℙ}_{( {E}_{1} , {E}_{2} )} , {ℙ}_{( {E}_{1} , {E}_{3} )} , {ℙ}_{( {E}_{2} , {E}_{3} )} ) = ϵ$$

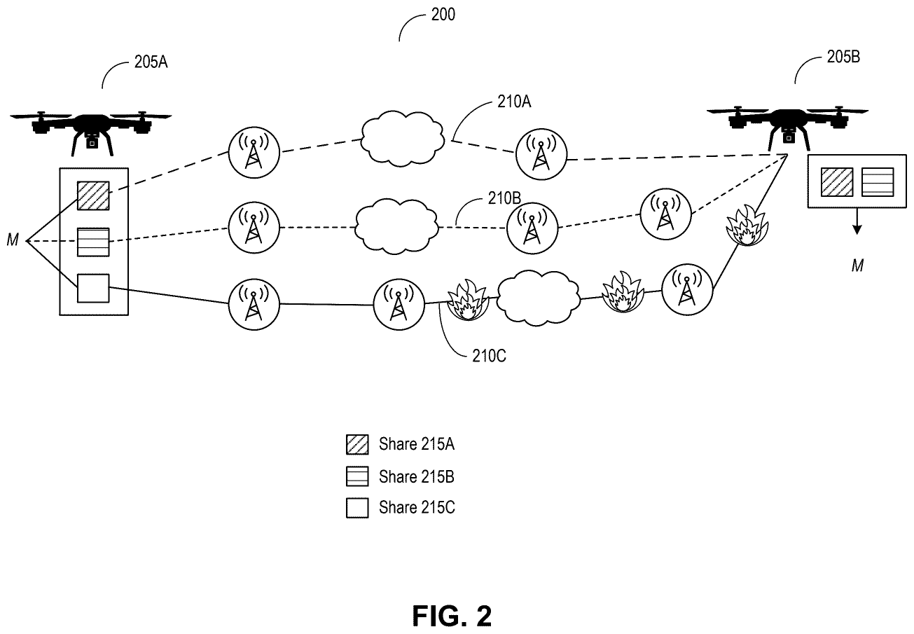

Referring now to FIG. 2, depicted is a block diagram of an environment 200 in which unmanned aerial vehicles (UAVs) 205A and 205B communicate over multiple paths 210A-C. The encoding schema may account for unanticipated attack recovery via multi-path communication, by adding a new dimension to security with a network coding approach and multiple communication paths. One share derived from the message does not reveal information about M (Quantum-resistant). The encoding schema may be proactive rather than reactive design, and may not solely rely on the security provided by 5G. In this manner, entire class of DoS attacks (at any layer) at a single relay may be defeated, without having to cooperate with network.

In the depicted example, the data M=M₁∥M₂ may be encoded into three shares 215A-C.

$$Share 215 A = ( \begin{matrix}{R}_{1} \\ {M}_{2} {R}_{2}\end{matrix} )$$

$$Share 215 B = ( \begin{matrix}{M}_{1} ⊕ {R}_{1} \\ {R}_{2}\end{matrix} )$$

$$Share 215 C = ( \begin{matrix}{M}_{1} ⊕ {R}_{2} \\ {M}_{2} ⊕ {R}_{12}\end{matrix} )$$

where R₁, R₂ are uniformly distributed over {0,1}^{|M|/2}

Each of the shares 215A-C does not reveal information about M. Any two shares allow recovery of M. The shares 215A-C may be of an optimal size and encoding and decoding may be performed using exclusive-or (XOR) operation. This operation may be of low complexity, free from reliance of computationally demanding finite field operations or interpolations.

### B. Systems and Methods Communicating Encoded Messages Via Multipath Communications to Counteract Against Attacks

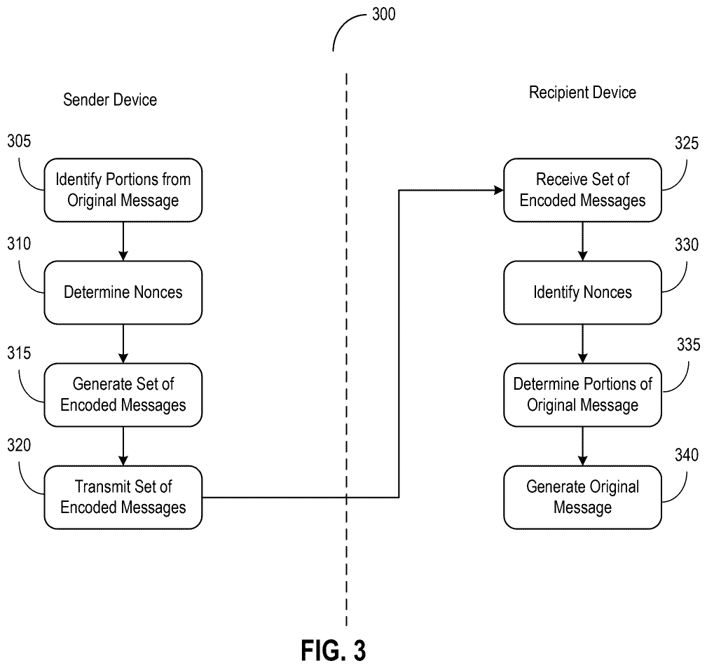

Referring now to FIG. 3, depicted is a flow diagram of a method 300 of communicating encoded messages via multipath communications to counteract against attacks along any of the paths. The method 300 may be implemented using or performed using any of the components detailed herein above, such as a base station, a user equipment (UE), an unmanned aerial vehicle (UAV), or any a wireless communication device, among others. In brief overview, under the method 300, a sender device may identify a set of portions from an original message (305). The sender device may determine a set of nonces (310). The sender device may generate a set of encoded messages (315). The sender device transmits the set of encoded messages to a receiver device (320). The receiver device may receive at least a subset of encoded messages (325). The receiver device may identify the nonces (330). The receiver device may determine the set of portions of the original messages (335). The receiver device may generate an original message (340).

In further detail, a sender device (e.g., a source UE or UAV 205A) may extract or identify a set of portions from an original message to transmit to a recipient device (e.g., a destination UE or UAV 205B) (305). The sender device and the recipient device may each be wireless communication devices (e.g., UAVs) communicating via a set of paths in a networked environment. Each path in the networked environment may be established, managed, or otherwise facilitated by one or more base stations (BS). The sender device may partition, divide, or segment the original message into the set of portions (sometimes herein referred to as shares). Each portion may correspond to a respective segment within the original message. The respective segments may be non-overlapping from one another. The original message may include information (e.g., in the form of binary sequence or a set of alphanumeric characters), and each portion may correspond to a respective segment from the message. Each portion may be of a set size and the size may be same for each of the set of portions. The original message may carry any information, for example, a command for the recipient device to fly to a particular location or data to be forwarded to another recipient.

In some embodiments, the sender device may calculate, identify, or otherwise determine a number of portions to identify from the original message. The number of portions may be based on factors of the networked environment, such as a number of paths between the sender device and the recipient device or a number of base stations between the sender device and the recipient device, among others. The number of portions may be based on properties of the original message, such as a size or length of the original message, among others. The identification of the number of portions may be based on the factors of the networked environment and the properties of the original message.

The sender device may calculate, generate, or otherwise determine a set of nonces to encode the set of portions (310). Each nonce may be a pseudo-random value (e.g., in the form of binary numbers, digit numbers, or alphanumeric characters) used to encode the portions of the original message. In some embodiments, the sender device may generate the set of nonces using a probability distribution function (e.g., uniform distribution, normal distribution, or Chi-squared) or cryptographic hash function (e.g., message digest algorithm (MDA) or secure hash algorithm (SHA)), among others. The sender device may generate a number of nonces equal to the number of portions identified from the original message.

The sender device may output, produce, or otherwise generate a set of encoded messages (315). For each path, the sender device may generate a corresponding encoded message to include at least two values. The first value may be based on a combination (e.g., an exclusive-or operation or modulo operation) of a respective portion of the set of portions of the message and a first nonce of the set of nonces to encode the respective portion. The second value may be based on a second nonce of the set of nonces to enable recovery of another portion. The second value may also be based on a combination (e.g., an exclusive-or operation or modulo operation) of another portion of the set of portions and the second nonce.

The set of encoded messages may each include a respective permutation of the portions and the nonces. For example, the first encoded message may include (i) a first value based on a combination of a first portion and the first nonce and (ii) a second value corresponding to a second nonce. The second encoded message may include a second encoded message comprising (i) a first value corresponding to the first nonce and (ii) a second value based on a combination of the second portion and the second nonce. The third encoded message may include (i) a first value based on a combination of the first portion and the second nonce and (ii) a second value based on a combination of the second portion and the first nonce. The set of encoded messages may include any number of messages.

The sender device may provide, send, or otherwise transmit the set of encoded messages via the set of paths to the recipient device (320). Each path may correspond to a communication channel (e.g., in a 5G network) between the sender device and recipient device through at least one base station in the network. There may be any number of paths and base stations between the sender and recipient devices. The encoding of the messages may be independent of any security measures provided by the base stations supporting the paths. The sender device may transmit each encoded message via a corresponding path of the set of paths between the sender device and the recipient device. From the example above, the sender device may send the first encoded message via a first path, the second encoded message via a second path, and the third encoded message via a third path to the recipient device.

The recipient device may retrieve, identify, or otherwise receive at least a subset of the encoded messages via the set of paths from the sender device (325). The recipient device may receive all of the encoded messages when none of the paths are impacted by attacks (e.g., denial-of-service). On the other hand, when at least one of the paths are impacted by attacks, the recipient device may receive a subset of the encoded messages (e.g., one less message than the original number of encoded messages). With receipt, the recipient device may process or parse each encoded message to extract or identify the first value and the second value therein. In some embodiments, the recipient device may determine or identify a number of encoded messages received from the sender device.

The recipient device may extract or identify at least one of the nonces from the set of encoded messages (330). From each encoded message, the recipient device may identify at least one of nonces using the first value or the second value (or both) in at least two of the encoded messages. For example, if the second and third encoded messages are received, the recipient device may identify the first nonce from the first value of the second encoded message. The recipient device may further identify the second nonce by first decoding (e.g., using an exclusive-or or modulo operation) the second portion using the second value of the second message with the second value of the third encoded message and then using the second portion to decode the second nonce from the first value of the third encoded message.

The recipient device may recover, identify, or determine the set of portions of the original messages (335). The recipient device may use the set of nonces identified from the encoded messages to determine the portions. For example, from the example above, the recipient device may use the first nonce to decode the second value of the third encoded message to recover (e.g., using an exclusive-or operation) the second portion of the original message. The recipient device may then use the second portion to decode the second value of the second encoded message to recover the second nonce. With the recovery, the recipient device may use the second nonce to then decode the first value of the third encoded message to recover the first portion of the original message.

The recipient device may reconstruct, determine, or otherwise generate the original message using the set of portions (340). With the identification of the set of portions, the recipient device may combine the portions to reconstruct the original message. The recipient device may identify the order in which to combine the portions based on the decoding operations applied to the encoded messages. With the recovery, the recipient device may perform any action specified by the original message, such as to fly to the particular location as specified in the command or forward data to another recipient.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled”, and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

The present technology may include, but is not limited to, the features and combinations of features recited in the following lettered paragraphs, it being understood that the following paragraphs should not be interpreted as limiting the scope of the claims as appended hereto or mandating that all such features must necessarily be included in such claims:
A. A system or method for encoding messages to send via multi-path communications, comprising:
   a first device comprising one or more processors, configured to:
      identify, from a first message to be transmitted via a plurality of paths to a second device, a plurality of portions each corresponding to a respective segment of the first message.
      determine a plurality of nonces to encode the plurality of portions;
      generate, for each path of the plurality of paths, a corresponding second message of a plurality of second messages to include (i) a first value based at least on at least one portion of the plurality of portions and a first nonce of the plurality of nonces and (ii) a second value based at least on a second nonce of the plurality of nonces; and
      transmit, via each path of the plurality of paths, the corresponding second message, to cause the second device to decode the first message using at least a subset of the plurality of second messages.
B. The system or method of Paragraph A, wherein the first device is further configured to determine a number of messages to transmit based at least on one of: (i) a number of base stations between the first device and the second device, (ii) a number of paths between the first device and the second device, or (iii) a size of the first message.
C. The system or method of any one or more of Paragraphs A or B, wherein the plurality of second messages comprises:
   a first encoded message comprising (i) a respective first value based on a combination of a first portion of the plurality of portions and the first nonce and (ii) a respective second value corresponding to the second nonce;
   a second encoded message comprising (i) a respective first value corresponding to the first nonce and (ii) a respective second value based on a combination of a second portion of the plurality of portions and the second nonce; and
   a third encoded message comprising (i) a respective first value based on a combination of the first portion and the second nonce and (ii) a respective second value based on a combination of the second portion and the first nonce.
D. The system or method of any one or more of Paragraphs A-C, wherein the first device includes an unmanned aerial vehicle in communication with the second device via a plurality of base stations corresponding to the plurality of paths.
E. The system or method of any one or more of Paragraphs A-D, wherein the first device is a user equipment.
F. The system or method of any one or more of Paragraphs A-E, wherein the second device is a user equipment or an unmanned aerial vehicle.
G. The system or method of any one or more of Paragraphs A-F, wherein each of the plurality of nonces is a pseudo-random value.
H. The system or method of any one or more of Paragraphs A-G, wherein the pseudo-random value includes at least one of: a binary number, a digit number, or an alphanumeric character.
I. The system or method of any one or more of Paragraphs A-H, wherein the first device is further configured to
   generate the first nonce of the plurality of nonces according to a probability distribution function or a cryptographic hash function.
J. The system or method of any one or more of Paragraphs A-I, wherein the first device is further configured to
   generate the second nonce of the plurality of nonces according to a probability distribution function or a cryptographic hash function.
K. A system or method for decoding messages to send via multi-path communications, comprising:
   a first device comprising one or more processors, configured to:
      receive, via at least a subset of a plurality of paths between the first device and the second device, a plurality of first messages each comprising: (i) a first value based at least on at least one portion of a plurality of portions and a first nonce of a plurality of nonces and (ii) a second value based at least on a second nonce of the plurality of nonces
      identify, using the first value and the second value in each of the plurality of first messages, the plurality of nonces used to encode the plurality of portions of a second message;
      determine, from each of the plurality of first messages, the at least one portion of the plurality of portions based on (i) the first value and (ii) at least one of the first nonce or the second nonce;
      generate a second message including the plurality of portions determined from the plurality of first messages.
L. The system or method of Paragraph K, wherein the first device is configured to determine the at least one portion of the plurality of portions based on an exclusive-or operation on (i) the first value and (ii) at least one of the first nonce or the second nonce.
M. The system or method of any one or more of Paragraphs K or L, wherein the plurality of second messages comprises:
   a first encoded message comprising (i) a respective first value based on a combination of a first portion of the plurality of portions and the first nonce and (ii) a respective second value corresponding to the second nonce;
   a second encoded message comprising (i) a respective first value corresponding to the first nonce and (ii) a respective second value based on a combination of a second portion of the plurality of portions and the second nonce; and
   a third encoded message comprising (i) a respective first value based on a combination of the first portion and the second nonce and (ii) a respective second value based on a combination of the second portion and the first nonce.
N. The system or method of any one or more of Paragraphs K-M, wherein the first device includes an unmanned aerial vehicle in communication with the second device via a plurality of base stations corresponding to the plurality of paths.
O. The system or method of any one or more of Paragraphs K-N, wherein the first device is a user equipment.
P. The system or method of any one or more of Paragraphs K-O, wherein the second device is a user equipment or an unmanned aerial vehicle.
Q. The system or method of any one or more of Paragraphs K-P, wherein each of the plurality of nonces is a pseudo-random value.
R. The system or method of any one or more of Paragraphs K-R, wherein the pseudo-random value includes at least one of: a binary number, a digit number, or an alphanumeric character.
S. The system or method of any one or more of Paragraphs K-R, wherein the first device is further configured to identify the plurality of nonces using a modulo operation of the first value and the second value in each of the plurality of first messages.
T. The system or method of any one or more of Paragraphs K-S, wherein the first device is further configured to determine the plurality of portions using a modulo operation (i) the first value and (ii) at least one of the first nonce or the second nonce.
U. The system or method of any one or more of Paragraphs K-T, wherein the first device is further configured to perform an action identified in the second message.

Other embodiments are set forth in the following claims, along with the full scope of equivalents to which such claims are entitled.

What is claimed is:

1. A system for encoding messages to send via multi-path communications, comprising:
a first device comprising one or more processors coupled with memory, configured to:
identify, from a first message to be transmitted via a plurality of paths to a second device, a plurality of portions each corresponding to a respective segment of the first message;
determine a plurality of nonces to encode the plurality of portions;
generate, for each path of the plurality of paths, a corresponding second message of a plurality of second messages to include (i) a first value based at least on at least one portion of the plurality of portions and a first nonce of the plurality of nonces and (ii) a second value based at least on a second nonce of the plurality of nonces; and
transmit, via each path of the plurality of paths, the corresponding second message, to cause the second device to decode the first message using at least a subset of the plurality of second messages.

2. The system of claim 1, wherein the first device is further configured to determine a number of messages to transmit based at least on one of: (i) a number of base stations between the first device and the second device, (ii) a number of paths between the first device and the second device, or (iii) a size of the first message.

3. The system of claim 1, wherein the plurality of second messages comprises:
a first encoded message comprising (i) a respective first value based on a combination of a first portion of the plurality of portions and the first nonce and (ii) a respective second value corresponding to the second nonce;
a second encoded message comprising (i) a respective first value corresponding to the first nonce and (ii) a respective second value based on a combination of a second portion of the plurality of portions and the second nonce; and
a third encoded message comprising (i) a respective first value based on a combination of the first portion and the second nonce and (ii) a respective second value based on a combination of the second portion and the first nonce.

4. The system of claim 1, wherein the first device includes an unmanned aerial vehicle in communication with the second device via a plurality of base stations corresponding to the plurality of paths.

5. The system of claim 1, wherein the first device is a user equipment and wherein the second device is a user equipment or an unmanned aerial vehicle.

6. The system of claim 1, wherein the first device is further configured to:
generate the first nonce of the plurality of nonces according to a probability distribution function or a cryptographic hash function; and
generate the second nonce of the plurality of nonces according to a probability distribution function or a cryptographic hash function.

7. A system for decoding messages to send via multi-path communications, comprising:
a first device comprising one or more processors coupled with memory, configured to:
receive, via at least a subset of a plurality of paths between the first device and the second device, a plurality of first messages each comprising: (i) a first value based at least on at least one portion of a plurality of portions and a first nonce of a plurality of nonces and (ii) a second value based at least on a second nonce of the plurality of nonces;
identify, using the first value and the second value in each of the plurality of first messages, the plurality of nonces used to encode the plurality of portions of a second message;
determine, from each of the plurality of first messages, the at least one portion of the plurality of portions based on (i) the first value and (ii) at least one of the first nonce or the second nonce;
generate a second message including the plurality of portions determined from the plurality of first messages.

8. The system of claim 7, wherein the first device is configured to determine the at least one portion of the plurality of portions based on an exclusive-or operation on (i) the first value and (ii) at least one of the first nonce or the second nonce.

9. The system of claim 7, wherein the plurality of second messages comprises:
a first encoded message comprising (i) a respective first value based on a combination of a first portion of the plurality of portions and the first nonce and (ii) a respective second value corresponding to the second nonce;
a second encoded message comprising (i) a respective first value corresponding to the first nonce and (ii) a respective second value based on a combination of a second portion of the plurality of portions and the second nonce; and
a third encoded message comprising (i) a respective first value based on a combination of the first portion and the second nonce and (ii) a respective second value based on a combination of the second portion and the first nonce.

10. The system of claim 7, wherein the first device includes an unmanned aerial vehicle in communication with the second device via a plurality of base stations corresponding to the plurality of paths.

11. The system of claim 7, wherein the first device is a user equipment and wherein the second device is a user equipment or an unmanned aerial vehicle.

12. The system of claim 7, wherein the first device is further configured to identify the plurality of nonces using a modulo operation of the first value and the second value in each of the plurality of first messages.

13. The system of claim 7, wherein the first device is further configured to determine the plurality of portions using a modulo operation (i) the first value and (ii) at least one of the first nonce or the second nonce.

14. The system of claim 7, wherein the first device is further configured to perform an action identified in the second message.

15. A method of encoding messages to send via multi-path communications, comprising:
identifying by a first device, from a first message to be transmitted via a plurality of paths to a second device, a plurality of portions each corresponding to a respective segment of the first message;
determining, by the first device, a plurality of nonces to encode the plurality of portions;
generating, by the first device, for each path of the plurality of paths, a corresponding second message of a plurality of second messages to include (i) a first value based at least on at least one portion of the plurality of portions and a first nonce of the plurality of nonces and (ii) a second value based at least on a second nonce of the plurality of nonces; and
transmitting, by the first device, via each path of the plurality of paths, the corresponding second message, to cause the second device to decode the first message using at least a subset of the plurality of second messages.

16. The method of claim 15, further comprising determining, by the first device, a number of messages to transmit based at least on one of: (i) a number of base stations between the first device and the second device, (ii) a number of paths between the first device and the second device, or (iii) a size of the first message.

17. The method of claim 15, wherein the plurality of second messages comprises:
a first encoded message comprising (i) a respective first value based on a combination of a first portion of the plurality of portions and the first nonce and (ii) a respective second value corresponding to the second nonce;
a second encoded message comprising (i) a respective first value corresponding to the first nonce and (ii) a respective second value based on a combination of a second portion of the plurality of portions and the second nonce; and
a third encoded message comprising (i) a respective first value based on a combination of the first portion and the second nonce and (ii) a respective second value based on a combination of the second portion and the first nonce.

18. The method of claim 15, wherein the first device includes an unmanned aerial vehicle in communication with the second device via a plurality of base stations corresponding to the plurality of paths.

19. The method of claim 15, wherein the first device is a user equipment and wherein the second device is a user equipment or an unmanned aerial vehicle.

20. The method of claim 15, further comprising:
generating, by the first device, the first nonce of the plurality of nonces according to a probability distribution function or a cryptographic hash function; and
generating, by the first device, the second nonce of the plurality of nonces according to a probability distribution function or a cryptographic hash function.
